(19) United States
(12) Patent Application Publication
(10) Pub. No.: US 2015/0061546 A1
(43) Pub. Date: Mar. 5, 2015

(54) TWO-OUTLET DIGITAL TIMER

(71) Applicant: American Tack & Hardware Co., Inc., Saddle River, NJ (US)

(72) Inventors: Michael STACK, Wanaque, NJ (US); Grady SCHENCK, Walden, NY (US); Eric CHEN, Ningbo City (CN)

(21) Appl. No.: 14/472,308

(22) Filed: Aug. 28, 2014

Related U.S. Application Data
(60) Provisional application No. 61/884,895, filed on Sep. 30, 2013.
(60) Provisional application No. 61/872,120, filed on Aug. 30, 2013.

(51) Int. Cl. G04G 15/00; H01R 13/70

(52) U.S. Cl. CPC G04G 15/006; H01R 13/70
USPC 315/360; 307/115

(57) ABSTRACT

A programmable timer for controlling two outlets that may be switched on and off in response to a programmed schedule where said programmable timer comprises an input device, a microprocessor, two switches and two outlets.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### REFERENCE TO A MICROFICHE APPENDIX

Not Applicable

### BACKGROUND OF THE INVENTION

1) Field of the Invention

This invention relates to a digital timer for controlling two outlets.

2) Description of Related Art

U.S. Pat. No. 5,160,853 discloses an electronic timer for turning a single light on and off in response to programming information stored in a microprocessor.

### SUMMARY OF THE INVENTION

This invention provides a single programmable timer for independently turning two separate outlets on and off in response to a programmed schedule. The programmable timer includes an input device, a microprocessor and two switches.

The input device provides programming information, consisting of switching time and which of the two outlets is to be switched on or off, to the microprocessor which stores the programming information. The microprocessor employs program logic that compares the programmed switching times to the current time and generates control signals to turn one or both outlets on or off as directed by the stored program. The two timing control signals in turn cause the two switches to turn their indicator lights on or off.

In one embodiment, the micro-processor and the switches are included within a housing which can be plugged into a grounded 120 volt wall outlet by way of a three pin plug that is disposed in one face of the housing. Power is received from the switches through two separate grounded 120 volt receptacles being disposed in opposite sides of the timer housing. A liquid crystal display is disposed in the housing face opposite the plug to provide a read out of the programming information, time of day, and on/off status of the two switches. Two LEDs are disposed on the same face to provide an illuminated indication of switch status that can be viewed in darkness. The input device is disposed on the same face of the housing and includes a key matrix having a plurality of finger settable key type programming switches. Information is programmed by pressing each key while the programming logic is in a particular programming mode. The input device, the status LEDS, and the liquid crystal display may be recessed into the face of the housing.

### BRIEF DESCRIPTION OF THE SEVERAL VIEWS OF THE DRAWINGS

FIG. 1 is a front view of a programmable timer according to the invention.

FIG. 2 is a side view of a programmable timer according to the invention.

FIG. 3 is an embodiment of a timer control circuit according to the invention.

FIG. 4 is a programmable timer screen according to the invention which shows a default setting.

FIG. 5 is a programmable timer screen according to the invention which shows a recently set time.

FIG. 6 is a programmable timer screen according to the invention which shows the display that is the default setting for outlets A and B.

FIG. 7 is a programmable timer screen according to the invention where only outlet A is being programmed.

FIG. 8 is a programmable timer screen according to the invention where only outlet B is being programmed.

FIG. 9 is a programmable timer screen according to the invention showing the default setting when both outlet A and B are on.

FIG. 10 is a programmable timer screen according to the invention where the countdown for an outlet A is being set.

FIG. 11 is a programmable timer screen according to the invention where the countdown for outlet B is being set.

FIG. 12 is a programmable timer screen according to the invention where random switching is being programmed.

FIG. 13 is a programmable timer screen according to the invention where outlets A and B are in the auto off position.

FIG. 14 is a programmable timer screen according to the invention where only outlet A is in the auto on position.

FIG. 15 is a programmable timer screen according to the invention where outlet A is in the manual on position and outlet B is in an auto off position and B are in the auto off position.

FIG. 16 is a programmable timer screen according to the invention where outlet A is in the manual off position and outlet B is in the auto off position.

FIG. 17 is a programmable timer screen according to the invention where a daylight savings time adjustment is displayed.

### DETAILED DESCRIPTION OF THE INVENTION

The invention provides a single programmable electronic timer which may be used to provide two timing signals for a variety of applications such as controlling power to two lights or other electrical loads. The timer may be set to independently turn each timing signal on or off as often as desired over the course the day. In the preferred embodiment the timer is included in a switching device for independently turning two separate outlets on and off accurately and precisely in a programmable sequence over time. There are also two keys that provide an override to the timer operation and allow independent manual control of the timing signals.

The electronic timer of the invention may be plugged into any grounded 120 volt receptacle. When two lamps are plugged into the two receptacles in the timer both lamps can be independently controlled by the timer. The timer will turn each of the lights on or off automatically a number of times during the day depending on stored programming information. The programmable timer also includes 2 keys that provide manual control of the lamps and a liquid crystal display which functions as a program read out, as a clock, and as an output switch indicator.

The invention is programmed by depressing button-like programming keys which set mode, program, hour, minute, day, on time, off time, lamp to be controlled and reset conditions. The programmable switch also comes with a rechargeable battery which permits programming before plugging in. The rechargeable battery also powers the programmable timer during power outages. The programmable timer may be plugged into the wall using the grounded plug disposed in on surface of the invention that is opposite to the surface containing the display, illuminated LEDs and programming keys.

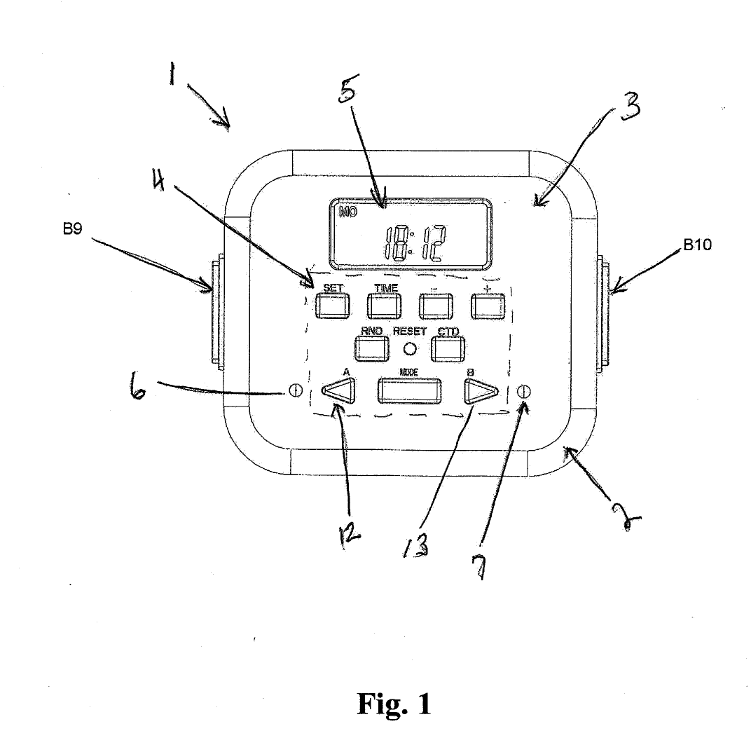

FIG. 1 is a front view of a programmable electronic timer according to the one embodiment of the invention. As shown in FIG. 1, the timer 1 includes a front housing 2. The front housing 2 has a face 3 on which is mounted several other components of the timer including a programming input device 4, a display 5, an indicator for switch A function 6, and an indicator for switch B function 7. In the preferred embodiment the programming input device 4 consists of a plurality of depressible key type switches, referred to hereafter as the key matrix.

The display 5 is a liquid crystal display in the preferred embodiment. The A switch indicator 6 and a B switch indicator 7 turn on to provide visual indication that the corresponding output is on.

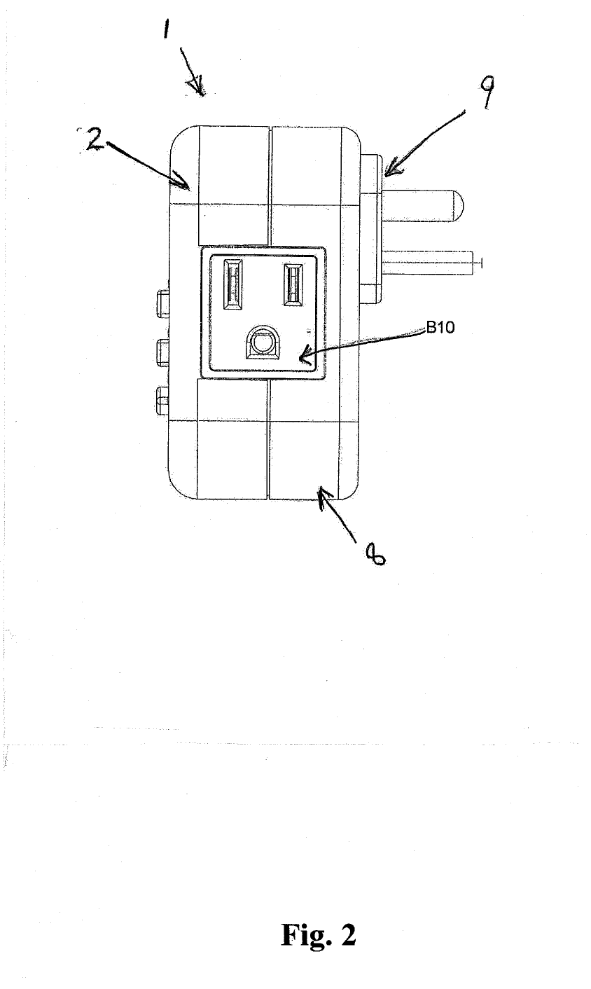

FIG. 2 is a side view of the electronic timer according to the invention. The programmable timer 1 includes a front housing 2 and a rear housing 8. The rear housing has disposed therein a three pin plug 9 for insertion into a standard 120 volt receptacle. FIG. 1 shows the controlled output receptacle B10 which is disposed between the front housing 2 and the rear housing 8. FIG. 1 shows the controlled output receptacle A11 which is disposed on the opposite side from controlled output receptacle B10. The receptacle for switch A11 is also disposed between the front housing 2 and the rear housing 8.

The display 5 is recessed into the front housing 2 and the key matrix (enclosed within the broken lines) is disposed so that the keys protrude through the front housing 2. An A switch indicator 6 is located in close proximity to the location of the A switch manual selection key 12 and a B switch indicator 7 is disposed near the location of the B switch manual selection key 13. Both indicator 6 and indicator 7 are disposed so they protrude through the front housing 2.

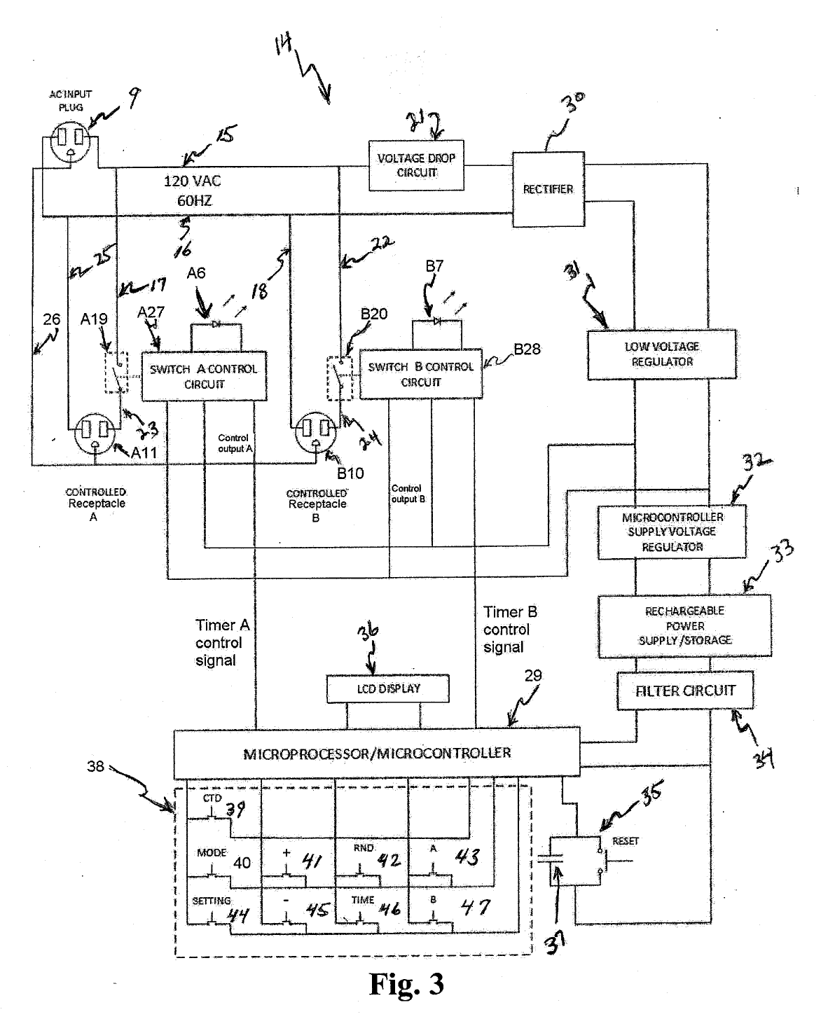

Front housing 2 and rear housing 8 contain control and switching circuits referred to hereinafter collectively as a timer control circuit 14. One embodiment of a timer control circuit according to the invention is shown in FIG. 3. The timer control circuit 14 in FIG. 3 receives 120 V AC power and independently provides 120V AC power to two separate outputs on a controlled basis.

The structure and operation of circuit 14 includes voltage control circuitry, a microprocessor, a programmable input device and related circuitry, and two switching circuits.

The microprocessor and programming circuits are used to selectively control the 2 switching circuits, the programming input device provides time, daylight savings time, mode, switching device, Manual override and other programming control information to the microprocessor.

The microprocessor provides 2 independent timer control output signals to the switch control circuits to turn two switches and their indicator lights on and off depending on the programming information stored in the microprocessor or manual override interrupts. Thus the circuit 14 can turn two independent lights on and off according to desired lighting objectives.

Discussing FIG. 3 in more detail, it can be seen that a 120V 60 Hz input enters the timer through AC input plug 9 to lines 15 and 16. Line 15 is coupled to the input of a voltage drop circuit 21. Line 15 is tapped and coupled directly by line 17 to an input side of control switch A 19. An output side of control switch A 19 is connected by line 23 to the switched side of controlled receptacle A11. A line 25 is tapped and coupled directly from line 16 to the non switched side of output receptacle A 11 and to the non switched side of output receptacle B 10. Line 15 is also tapped and coupled directly by line 22 to an input side of control switch B 20. An output side of control switch B 20 is connected by line 24 to the switched side of controlled receptacle B 10. Line 26 directly connects the ground pins of plug 9 and controlled outlet A 11 and controlled outlet B 10.

Switch A 19 is controlled by switch A control circuit A27 which also controls indicator A6 turning the indicator on when the switch is closed. Switch control circuit A27 is in turn controlled by Timer A Control Signal from the microprocessor 29. In the same manner, switch B20 is controlled by switch B control circuit B28 which also controls indicator B 7 turning the indicator on when the switch is closed. Switch control circuit B 28 is, in turn, controlled by Timer B Control Signal from the microprocessor 29.

Switch A control circuit A27 and switch B control circuit B28 can thus be independently controlled by timer control output A and timer control output B from microprocessor 29. Microprocessor 29 is controlled by programming inputs from key matrix 38 which corresponds to Key matrix 4 in FIG. 1 and by its programming logic.

The switch A control circuit A27, switch control circuit B28 and the microprocessor 29 will require regulated voltage inputs. Therefore voltage control circuits are included between the 120 VAC input and inputs to switch A control circuit A27, switch B control circuit B28 and microprocessor 29. Consequently line 15 from AC input plug 9 is connected through voltage drop circuit 21 to one input of rectifier 30. Line 16 directly connects the AC input to the other input to rectifier 30. Rectifier circuit 30 converts the AC input to DC. The output of rectifier 30 is coupled to a low voltage regulator 31.

Low voltage regulator 31 maintains the DC voltage at a constant voltage. One power output of the low voltage regulator 31 is coupled to inputs to switch A control circuit A27 and to switch B control circuit B28 to provide power for operating switch A control circuit A27 and switch B control circuit B28.

Another output of low voltage regulator 31 is coupled to additional circuitry which provides more regulation to the voltage before it is supplied to the microprocessor 29.

A second power output from low voltage regulator 31 is provided to microcontroller supply voltage regulator 32. Microcontroller supply voltage regulator 32 maintains the input voltage to microprocessor 29 within a very narrow range. An output of microcontroller supply voltage regulator 32 is coupled to a rechargeable power supply/storage device 33. This rechargeable supply could be a battery or other large capacity device.

The output of the rechargeable power supply/storage device 33 is coupled to the input of a filter circuit 34. A first line output from the filter circuit 34 is coupled to an input to the Microprocessor 29. A second line output from the filter circuit 34 is coupled to an input of microprocessor 29 and to an input to reset key 35. Reset key 35 is bypassed by a capacitor 37 the second side of the reset key is coupled to an input of microprocessor 29.

A liquid crystal display device 36 which corresponds to the display 10 in FIG. 1 is coupled to outputs from microprocessor 29.

Microprocessor 29 is controlled by programming inputs from Key matrix 38 which corresponds to key matrix 4 in FIG. 1 and reset key 35. Microprocessor 29 includes a memory (not shown). It should be understood that the reset key 35 may be physically located in close proximity with the other switches in the key matrix 38.

The Key matrix 38 includes a plurality of finger settable programming switches. In one embodiment of the invention each switch consists of a dome type button which completes an electrical circuit when depressed. An input side of each switch is connected to an output from the microprocessor 29 and an output side of each switch is connected to an input to the microprocessor 29. Thus microprocessor 29 senses a complete circuit (i.e. a voltage change) when a particular switch is depressed.

Microprocessor 29 also has a first output that provides a timer A control signal to switch A control circuit A27 and a second output that provides a timer B control signal to switch B control circuit B28. The time A control signals cause the switch A control circuit A27 to open switch A19 and turn off switch A indicator 6 or close switch A19 and turn on switch indicator 6. The time B control signals cause the switch B control circuit B28 to open switch B20 and turn off switch B indicator 7 or close switch A20 and turn on switch indicator 7. This enables to processor to selectively provide power to controlled AC outlet A11 and controlled AC outlet B10.

The timer face panel, as shown in FIG. 1, may be operated according to the following procedure:

SET/TIME: to set the current time

[+] or [−]: Increase or Decrease time setting

RND: Press Random ON/OFF setting to activate random delay for start or finish of ON periods.

RESET: In this instance to reset, press reset key with pointed object, i.e. pencil. (Reset Timer before programming first time.)

CTD: Countdown indicates time left before appliance is turned off.

MODE: Manual/Auto override

If programming is interrupted for more than 30 seconds while setting Timer, unit will automatically revert to default mode. Preset time will be preserved.

Setting Time:

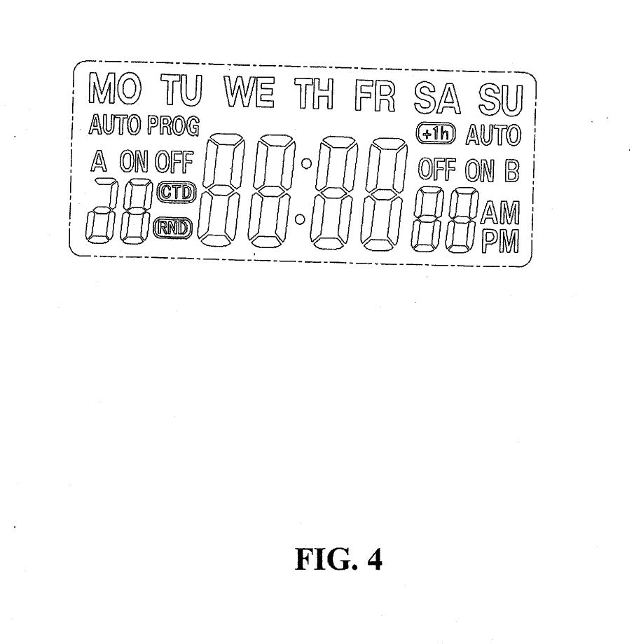

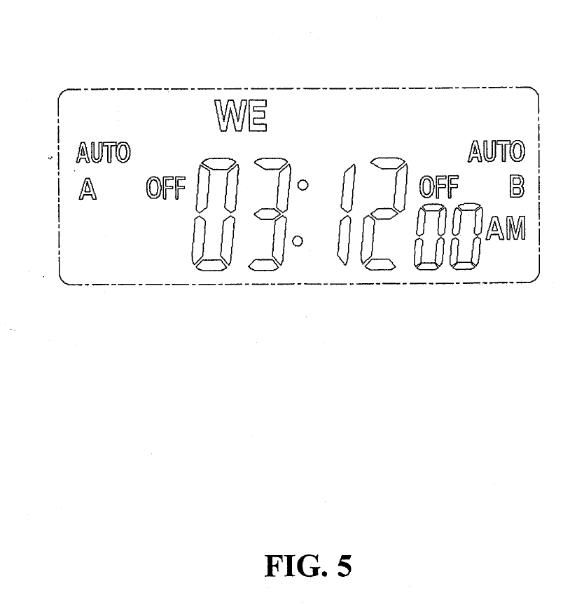

If the display as shown in FIG. 4 does not appear, plug unit into wall receptacle and charge battery for 1 hour.
1. The user may remove the unit from the wall to begin programming.
2. To select 12 or 24 hour clock press and hold TIME key for around 3 seconds. Release the time key when AM is in lower right corner to select 12 hour clock. No AM in the corner indicates 24 hour clock.
3. Press and hold SET key for around 3 seconds until “Mo” display begins flashing. Press [+] or [−] keys to select current day and press the SET key to confirm the Day selection.
4. The hour display will begin flashing. Press the [+] or [−] key to select hour. (Note AM or PM for twelve hour clock) Press the SET key to confirm the selection.
5. The minute display will start flashing. Press [+] or [−] keys to select minutes and press SET key to confirm minute selection.
6. Time is now set.
1) For example, the display, as shown in FIG. 5, is Wednesday 3:12 AM.

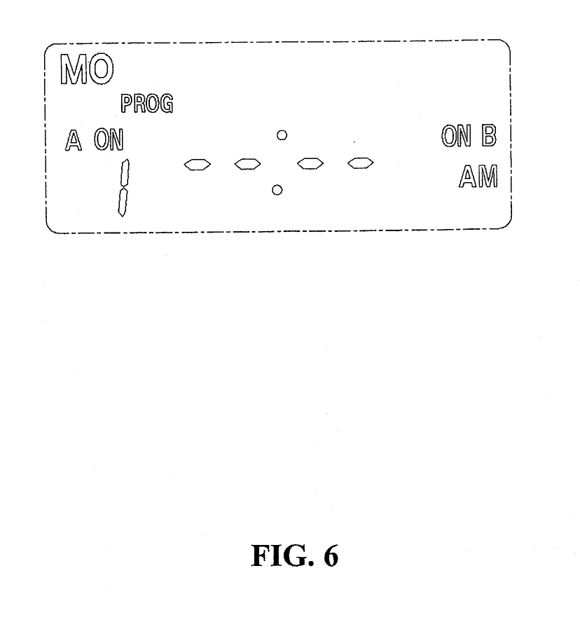

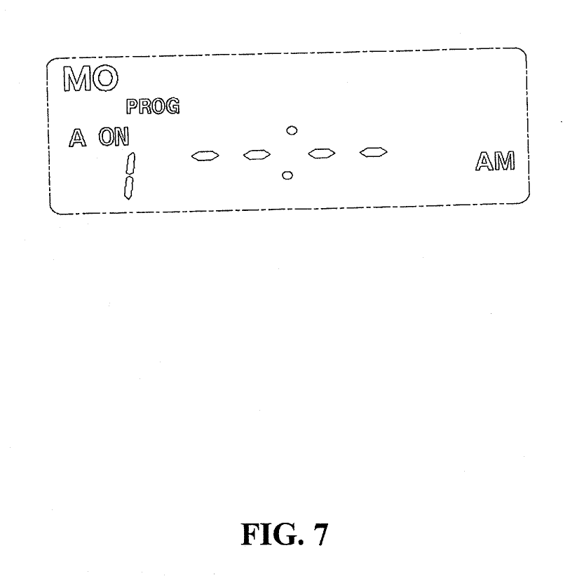

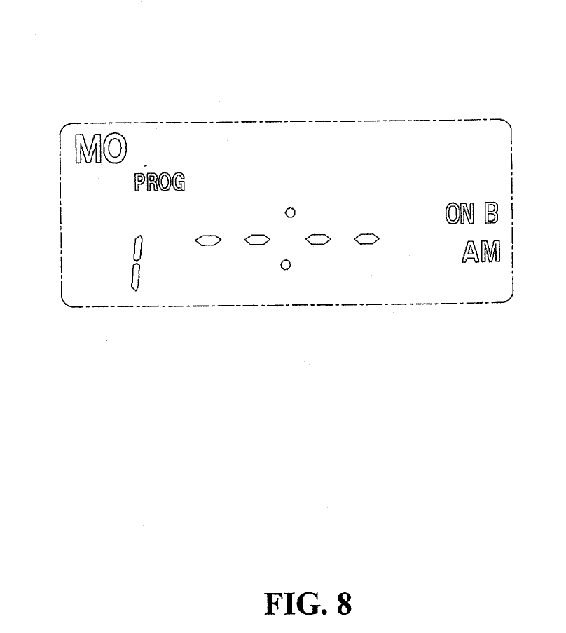

Programming On/Off Settings (Maximum 20 Events)
1. Clock time must be set before programming ON/OFF times.
2. After clock has been set, press [+] key. Display will look as shown in FIG. 6. “PROG” “1” “A ON” “ON B” this is the default setting for outlet A and B in Program 1. If you want the default setting press SET key to confirm selection and go to step 4.
3. If you want to select the desired output;
   Press A if you want to program outlet A only and the display will look as shown in FIG. 7.
   Press B if you want to program outlet B only, the display will look as shown in FIG. 8.
   Press and release A and B simultaneously to select both outlet A and B (default setting above), once the desired output combination is displayed press SET key to confirm selected output options.
4. Use [+] or [−] keys and select block of days.
   Options are:
   MO TU WE TH FR SA SU
   Individual day of the week
   MO TU WE TH FR (Weekdays only)
   SA SU (Weekends only)
   TH FR SA
   MO TU WE
   TU TH SA
   MO WE FR
   press B key to confirm selection
5. Select hour, using [+] or [−] keys. Press SET key to confirm selection.
6. Select minute, using [+] or [−] keys. Press SET key to confirm selection.
7. Press [+] key to start PROG1 OFF setting selection.
   NOTE: The output selection that is made for each PROG ON will be used in the PROG OFF for that program number. For example When the user has set output “A” for program 1 on settings and then selects PROG 1 “OFF” the timer software will look at what output was turned on and then turn only that output (“A”) off in PROG 1 OFF.
   What the user will see is the selected output (S) that will be turned off. He will not be allowed to change them. He can only select the time that he wants the outputs turned off.
8. Repeat steps 4 thru 6 to set day(s) and time device should turn OFF.
   Note: In one programmed ON/OFF cycle, you cannot change A/B selection. See step 7 above.
9. To set additional ON/OFF cycles, (maximum 20 events), press [+] key. Then press [+] or [−] keys and follow procedures in steps 3 thru 8 for each new ON/OFF cycle.
10. When finished programming ON/OFF cycles, press TIME key. Display will show current time.

Deleting Programs

1. Press [+] key. Use [+] or [−] keys to select ON/OFF cycle to be deleted.

2. Press SET key to select cycle. Press MODE key to delete program setting. Note: in step 2, press MODE again to recover the settings. After pressing MODE do not change the A/B/AB setting, or it will make the setting recovery impossible.

3. When done, press TIME key to return to current time and day.

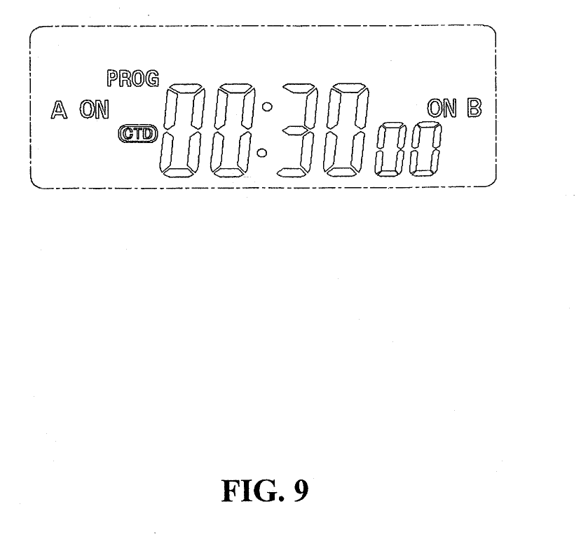

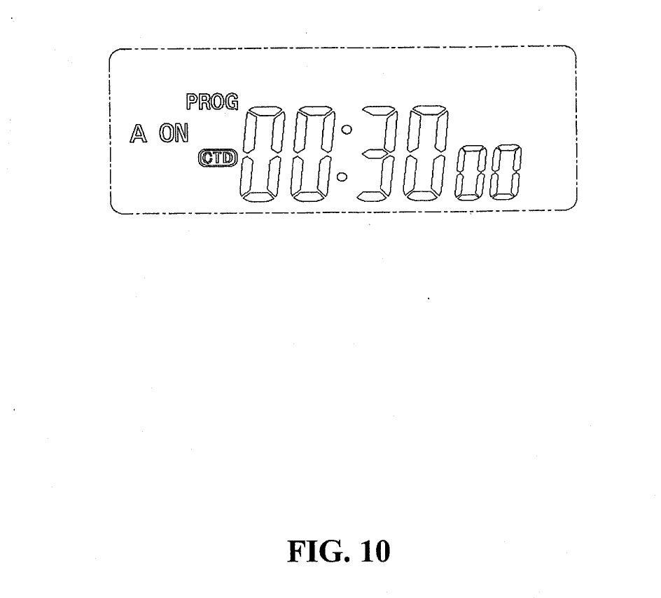

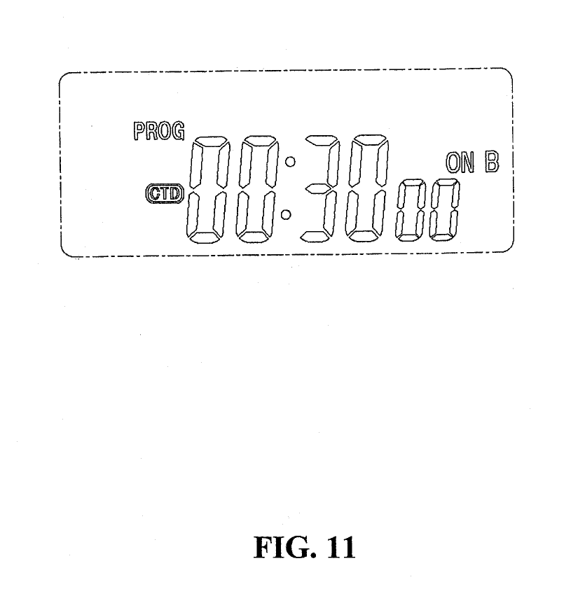

Count Down On/Off Setting
1. Press [−] key. Display will look as shown in FIG. 3, indicating “CTD” and “PROG” to indicate programming of Count Down Timer.
   The default setting for the countdown timer (CTD) is both outlets on. In the display shown in FIG. 9 you will see (A ON and ON B) flashing.
2. If you want the default setting press the SET key to select A and B.
   a. Use [+] or [−] keys select CTD AB hour(s).
   b. Press SET key to confirm selection.
   c. Use [+] or [−] keys to enter CTD AB minutes.
   d. Press SET key to confirm selection.
   e. Use [+] or [−] keys to enter CTD AB seconds.
   f. Press SET key to confirm selection and go to STEP 4
OR.
3. To select single A or B outputs press the selected button A or B. In the display you will see A ON as shown FIG. 10 or ON B as shown in FIG. 11 flashing. Press SET to confirm selection. The selected outputs will stop flashing and remain on while the Count-down time is set. The digits for hours will start flashing.
   a. Use [+] or [−] keys select CTD A or B hour(s).
   b. Press SET key to confirm selection.
   c. Use [+] or [−] keys to enter CTD A or B minutes.
   d. Press SET key to confirm selection.
   e. Use [+] or [−] keys to enter CTD A or B seconds.
   f. Press SET key to confirm selection.
   g. Repeat step three to program the second output if desired.
4. Press CTD key to start count down, “CTD” will remain on to indicate Count Down mode. If “A ON” and “ON B” are controlled by the same count down then “A ON” and “ON B” will both be displayed. If “A ON” and “ON B” are controlled by separate count-down then they will be displayed alternately in 3 second intervals on the LCD. Press A or B to choose which one you would like to monitor. The selected output will be displayed for 15 seconds and then the outputs will start to alternate again. While the Count-down timer is running you can press the CTD key again to pause the count-down. Both Timer A and Timer B will be paused and output A and B will be turned off.
   “CTD” and “OFF” will still show in the display to indicate that the timer is still in the count-down mode. Timer will remain in the CTD mode until:
   1) The CTD key is pressed again the selected CTD outputs are turned on again, and “A” and “B” count-down continues until it reaches zero and outputs are turned off. OR
   2) the TIME key is pressed which will cause both the “A” and “B” CTD counters to be set to zero. The CTD in the display will be turned off, only the selected “A” and/or “B” outputs to will turned off and the timer will return to the Automatic timer mode.

Random Switching

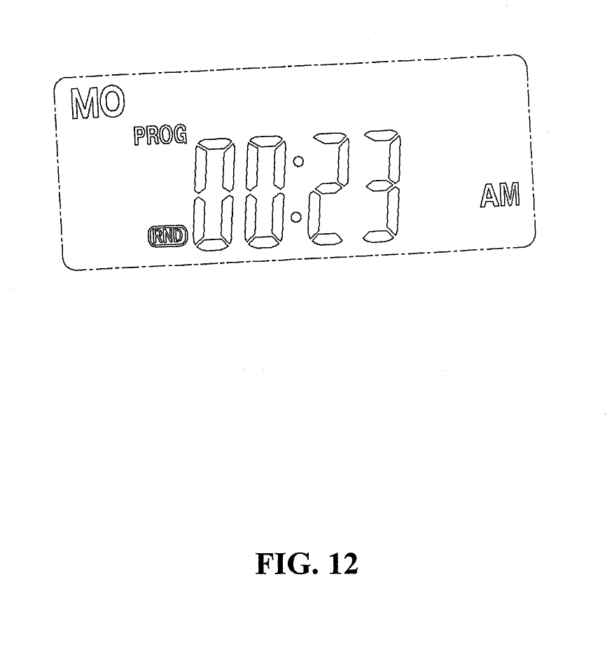

This feature can be used to turn lamps and appliances on and off in a random pattern. It is especially useful during vacations, so the home may appear to be occupied. Press RND. Display shows as in FIG. 12, indicating that the random program is now activated for both outlet A and B, the timer will turn ON/OFF after a randomly chosen time of 2 to 30 minutes after the setting in the program. To deactivate random mode, press RND again.

The timer may be programmed so that the two outlets have two random independent offsets for the two outputs. The next available on/off time for each output is offset by a number from +30 minutes to −30 minutes. The value of the offset is a calculated value that may be calculated using a pseudo random number generator. Random timing may be done electro-mechanically using the apparatus of U.S. Pat. No. 4,219,741 or an electronic system such as that which is disclosed by U.S. Pat. No. 5,258,656, both of which are incorporated by reference.

Manual Override

You can manually override the timer function in two ways.

1. Pressing the A or B key will cause the associated output to toggle on or off without affecting the other outlet. If the A or B output is in the AUTO mode the output will again be controlled by the timer at the next programmed ON/OFF time.

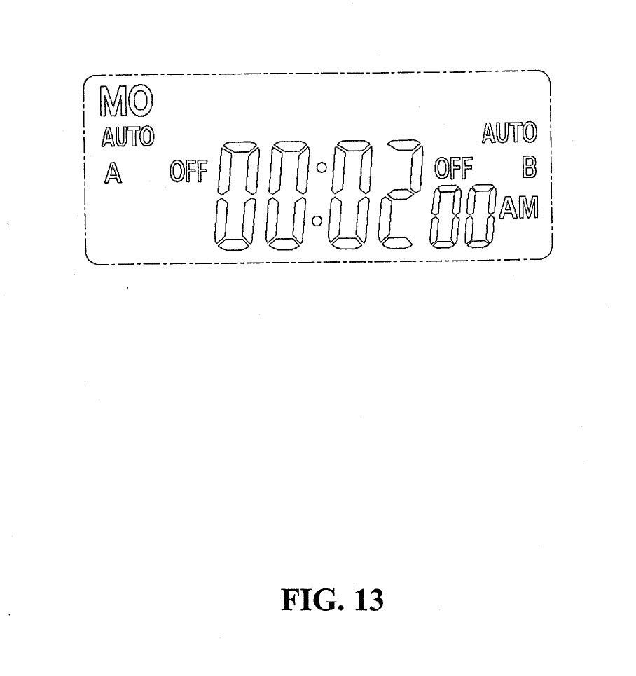

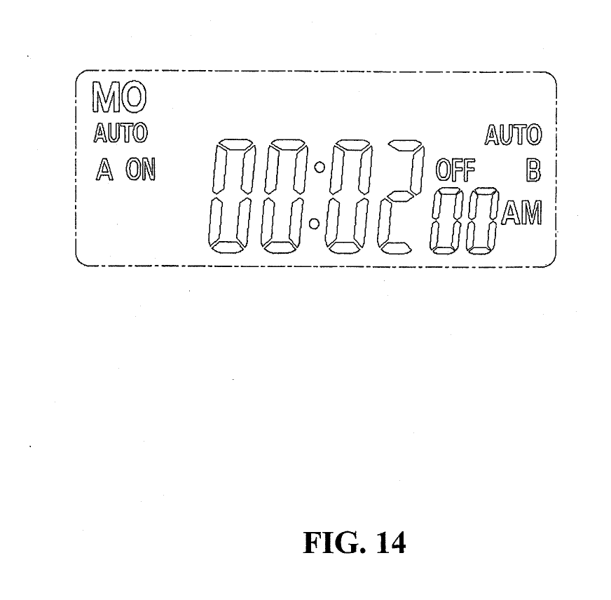

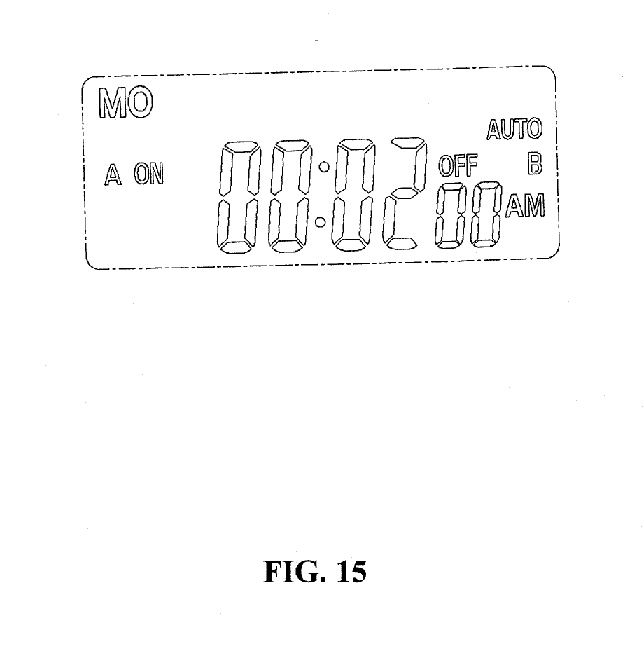

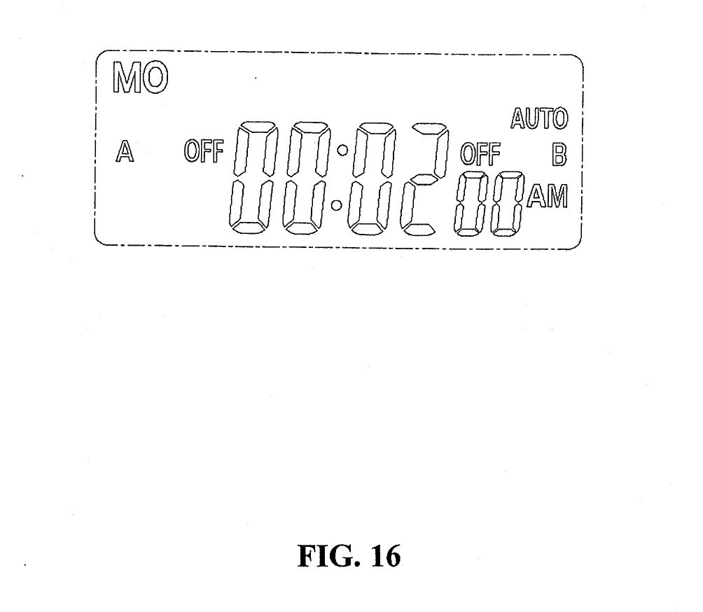

2. The A and B outputs can be run separately in the Auto or Manual mode by pressing and holding down the MODE key then press A/B button to select Auto or Manual operation for that output.
a. Default setting will look like FIG. 13. “A AUTO OFF” means outlet A will stay OFF until the next program turns it ON.
b. Press A, change to “A AUTO ON”, as shown in FIG. 14. This means outlet A will stay on until the next program turns it OFF.
c. To select Manual mode for output A, press and hold down the MODE key then press the button until AUTO is no longer displayed as shown in FIG. 15. Release the A button to confirm manual mode selection. (You can hold the MODE key and press the button again to enter AUTO mode then release the MODE key to confirm your selection) When the operating mode is selected for output A it will not affect outlet B.
d. Pressing the A button will change the “A ON” status to “A OFF” as shown in FIG. 16. When this screen is displayed the B output will be controlled by the timer program but the A output can only be changed by Pressing the A button.

Note: whenever an outlet is on, the related LED indicator will turn on; if an outlet is off, the related LED indicator will turn off

DST (Daylight Saving Time) Setting

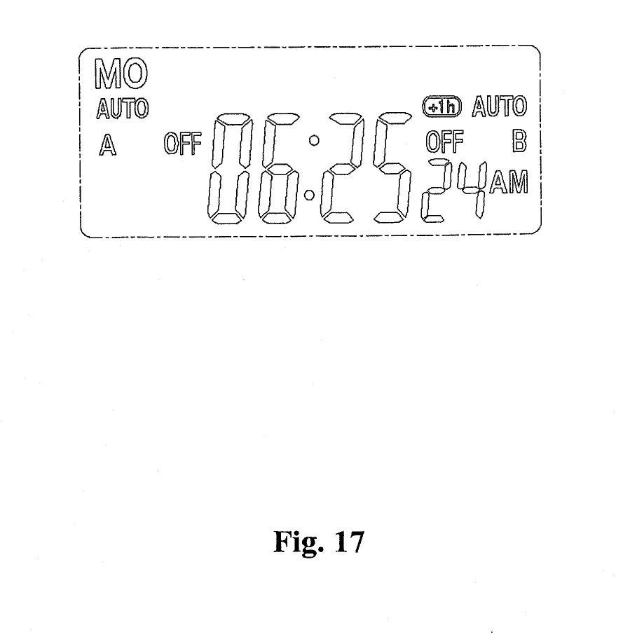

Press “TIME” key and [+] key simultaneously, “+1 h” will display on LCD as shown in FIG. 17 and time will add 1 hour. Press “TIME” key and [+] key again to cancel DST setting.

Reset Function

Press RESET key, Timer will resume in default status. All time and program information will be lost.

1. A programmable timer for controlling two outlets that may be switched on and off in response to a programmed schedule where said programmable timer comprises an input device, a microprocessor, two switches and two outlets.

2. The programmable timer as defined in claim 1 wherein the timer includes programming information comprising switching time and which of the two outlets are to be switched on or off.

3. The programmable timer as defined in claim 1 where said microprocessor employs program logic that compares the programmed switching times to the current time and generates control signals to turn one or both outlets on or off.

4. The programmable timer as defined in claim 1 where said input device has one or more keys that provide an override to the timer operation to allow independent manual control of the outlets.

5. The programmable timer as defined in claim 1 where the input device has mounted on a surface, a standard three blade 120 volt connector.

6. The programmable timer as defined in claim 1 where said two outlets are independently controlled by the timer.

7. The programmable timer as defined in claim 1 where each of the outlets are turned on or off a number of times during the day depending on stored programming information.

8. The programmable timer as defined in claim 1 where the input device includes 2 keys that provide manual control of the lamps and a liquid crystal display which functions as a program read out as a clock and as an output status indicator.
